(19) United States
(12) Patent Application Publication
(10) Pub. No.: US 2019/0240683 A1
(43) Pub. Date: Aug. 8, 2019

(54) System for Controlling Water Flowrate Output of Fluid Dispensing System

(71) Applicant: Carolyn Arthurs, Metairie, LA (US)

(72) Inventors: Carolyn Arthurs, Metairie, LA (US); Richard Chapin Bernard, Frisco, TX (US); Nathan Huntoon, Frisco, TX (US); Isabella Jimenez, Frisco, TX (US); Corbin Anthony Lyle, Plano, TX (US); Joshua Martinez, Frisco, TX (US); Robert Martinez, McKinney, TX (US); Laila Mitchell, Frisco, TX (US); Anirudh Selvakumar, Frisco, TX (US); Teri Mitchell, Frisco, TX (US); Saketh Ram Kotamraju, Frisco, TX (US)

(21) Appl. No.: 16/265,795

(22) Filed: Feb. 1, 2019

Related U.S. Application Data
(60) Provisional application No. 62/625,947, filed on Feb. 2, 2018.

(51) Int. Cl. B05B 1/30; F16K 31/60

(52) U.S. Cl. CPC B05B 1/30; F16K 31/602

(57) ABSTRACT

A system for regulating the flowrate of a nozzle apparatus is disclosed. The system comprises a flowrate control device having a body that is affixed between an upper lever portion and a lower portion of the nozzle apparatus to prevent the handle from being fully depressed. This system is adjustable by the user to allow the user to set the body to a desired position to get a desired flowrate. The system may be used to retrofit an existing nozzle apparatus, such as those seen on water tankers.

### CROSS-REFERENCE TO RELATED APPLICATIONS

This application claims priority to U.S. Provisional Patent Application No. 62/625,947, entitled “A SYSTEM FOR CONTROLLING WATER FLOWRATE OUTPUT OF FLUID DISPENSING SYSTEM” filed on Feb. 2, 2018, which is incorporated by reference herein for all purposes.

### FIELD OF INVENTION

The invention generally related to hydration systems for sports teams.

### BACKGROUND

Staying hydrated is of paramount importance on a sports field. Portable hydration systems known as “water power tankers” or “water cows” are being used at all level of sports play, from junior league to the professionals, to provide cool water to participants on the field for the entire game or during multiple games. The system avoids the paper and plastic cups littering the field. The power tankers work in a variety of ways, but they all have a tank of water that is mounted on or incorporated into a frame with wheels and can be pressurized to dispense water through multiple hoses coupled at one end to the water tank and the other end to a nozzle. The nozzle is comprised of a lever that is depressed by a player to open a valve and squirt a flow of water into the player's mouth or over their body.

### SUMMARY

Most mobile hydration systems for sports teams pump water at a much higher rate and pressure than a participant is able to consume. Participants routinely fully depress the handle, as is natural. This full depression, while quick and natural, releases the water at a high enough pressure and rate that users generally hold the nozzle away from their mouth and spray the water to the side in front of their mouth. The user then sucks in this water similar to how a water fountain is utilized. In doing this, a lot of water falls to the ground as waste since the water is not directed into the user's mouth. The inventors have calculated that typically 33% of water is wasted in this fashion. In other words, for 300 mL of water output from the nozzle 100 mL of water falls to the ground. The wasted water has essentially no redemptive value, particularly for events played on artificial turf. Because the water tanks on the mobile hydration systems are sometimes quite large, they are a source of a lot of wasted water.

The present invention addresses this shortcoming in existing mobile hydration systems for sports teams by limiting the maximum flow rate of water that a participant can release through a valve of a nozzle on the end of a hose coupled with the pressured water tank, thus reducing both the volume and force with which it is delivered so that a user may direct the stream directly into the user's mouth. The invention does not require changing the design of existing mobile hydration systems and can be retrofitted to existing system already in use on playing fields as well as new systems being manufactured.

In an exemplary embodiment, a flowrate control device installed on a nozzle of a mobile hydration system is capable of reducing the amount of wasted water up to 100%. Thus, for 300 mL of water output from the nozzle it is possible for none of this water to be wasted. This in turn not only saves water from a conservation standpoint, but also results in cost savings on water and reduces the frequency with which the water tanks on the mobile hydration systems need to be refilled.

In accordance with one aspect of the exemplary embodiment, the flowrate control device is retrofitted to an existing nozzle. In addition, the flowrate control device can be adjusted so as to allow a desired flowrate and pressure to be selected. The flowrate control device may be embodied in the form of a block, having a cross-sectional area of any shape or combination of shapes such as but not limited to: a circle, a triangle, a square, a rectangle, a trapezoid, a pentagon, a hexagon, an octagon, or a star. The block may be composed of any sort of mostly rigid material such as but not limited to: plastic, wood, metal, rigid polystyrene, or rubber. The block is affixed to the bottom portion of the nozzle apparatus utilizing some sort of fastener such as but limited to: a plastic ratchet fastener, glue, a screw, a nail, a hinge, a compression fitting, rope, string, a quick tie, or a pipe fastener. The block may be attached by the fastener in such a way that the fastener either goes over the top of the block, runs through the block, runs through a hole in the block, sits in a channel of the block, or other methods that would be known to a person in the art. The block is positioned in such a manner to provide the desired flowrate output by limiting the travel of the upper lever portion of the nozzle by hitting the bottom portion before full depression of the lever and thus limiting the opening of the valve in the nozzle apparatus.

In another embodiment, the flowrate control device may be retrofitted to the upper lever portion of the nozzle apparatus. The device can be adjusted so as to allow the user to select their desired flowrate. The flowrate control device may be embodied in the form of a block, having a cross-sectional area of any shape or combination of shapes such as but not limited to: a circle, a triangle, a square, a rectangle, a trapezoid, a pentagon, a hexagon, an octagon, a star, or an area matching the inside hollow portion of the lever of the nozzle apparatus. The block may be composed of any sort of mostly rigid material such as but not limited to: plastic, wood, metal, rigid polystyrene, or rubber. The block is affixed to the upper lever portion of the nozzle apparatus utilizing some sort of fastener such as but limited to: a plastic ratchet fastener, glue, a screw, a nail, a hinge, a compression fitting, rope, string, a quick tie, or a pipe fastener. The block may be attached by the fastener in such a way that the fastener either goes over the top of the block, runs through the block, runs through a hole in the block, sits in a channel of the block, or other methods that would be known to a person in the art. The block is positioned in such a manner to provide the desired flowrate output by limiting the travel of the upper lever portion of the nozzle by hitting the bottom portion before full depression of the lever and thus limiting the opening of the valve in the nozzle apparatus.

In another exemplary embodiment, the flowrate control device could be a block having a cross-sectional area of a combination of shapes where one portion of the block has a cross-sectional area of a shape including but not limited to: a circle, a triangle, a square, a rectangle, a trapezoid, a pentagon, a hexagon, an octagon, or a star. The block may be composed of any sort of mostly rigid material such as but not limited to: plastic, wood, metal, rigid polystyrene, or rubber. The block may have another portion that has a cross-sectional area more akin to a semicircular or circle. This semicircular or circular portion has a hinge or other means on one side of the block for allowing the semicircular or circular portion to swing open and closed. This semicircular or circular portion also has a latch or other means of clasping the portion. Thus, the block as a whole may be affixed to the upper or lower portion of the apparatus without an additional fastener.

In other embodiments, the flowrate control device having similar characteristic to the previous two embodiments is installed by the manufacturer during the manufacturing process. The device in this instance may be a separate device or may be integrated into the upper lever portion or the bottom portion of the nozzle apparatus, perhaps by changing the mold utilized to produce the nozzle housing.

### BRIEF DESCRIPTION OF FIGURES

FIG. 1A is a plan view showing an embodiment of a flow control device in the form of a rectangular block attached to the lower portion of a nozzle apparatus using a fastener that crosses over the top of the block.

FIG. 1B is a plan view showing an embodiment of the flow control device in the form of a cylindrical block attached to the lower portion of the nozzle apparatus using a fastener that crosses through a hole in the block.

FIG. 1C is a plan view showing an embodiment of the flow control device in the form of a block with a triangular cross-sectional area attached to the lower portion of the nozzle apparatus using a fastener that crosses through a hole in the block.

FIG. 2A is a plan view showing the flow control device of FIG. 1A in the form of a rectangular block attached to the lower portion of a nozzle apparatus using a fastener that crosses over the top of the block.

FIG. 2B is a plan view showing the flow control device in the form of a rectangular block attached to the lower portion of the nozzle apparatus using a fastener that crosses through a hole in the block.

FIG. 2C is a plan view showing an embodiment of the flow control device in the form of an upper portion being a rectangular block with a cylindrical lower portion that has a hinge and a method of latching to allow the device to clamp around the lower portion of the nozzle apparatus to secure the device.

FIG. 3A is a perspective view of the embodiment of the flow control device in the form of a rectangular block.

FIG. 3B is a perspective view of the embodiment of the flow control device in the form of a rectangular block with a hole through the block.

FIG. 3C is a perspective view of the embodiment of the flow control device in the form of an upper portion being a rectangular block with a lower portion being cylindrical with a hinge and a latch to allow the device to clamp around the nozzle.

FIG. 4A is a plan view showing an embodiment of the flow control device in the form of a rectangular block attached to the upper portion of the nozzle apparatus using a fastener that crosses over the top of the block.

FIG. 4B is a plan view showing an embodiment of the flow control device in the form of a rectangular block attached to the upper portion of the nozzle apparatus using a fastener that crosses through a hole in the block.

FIG. 4C is a plan view showing an embodiment of the flow control device in the form of an upper portion being a rectangular block with a cylindrical lower portion that has a hinge and a method of latching to allow the device to clamp around the upper portion of the nozzle apparatus to secure the device.

FIG. 5 is a perspective view of an embodiment of the flow control device in the form of an L-shaped trapezoid block.

FIG. 6 is a perspective view of the bottom of the flow control device of FIG. 5.

FIG. 7 is a plan view showing the flow control device in the form of an L-shaped trapezoid block attached to the lower portion of the nozzle apparatus using a fastener that crosses through a hole in the block.

### DETAILED DESCRIPTION OF EXEMPLARY EMBODIMENTS

In the following descriptions, like numbers refer to like elements.

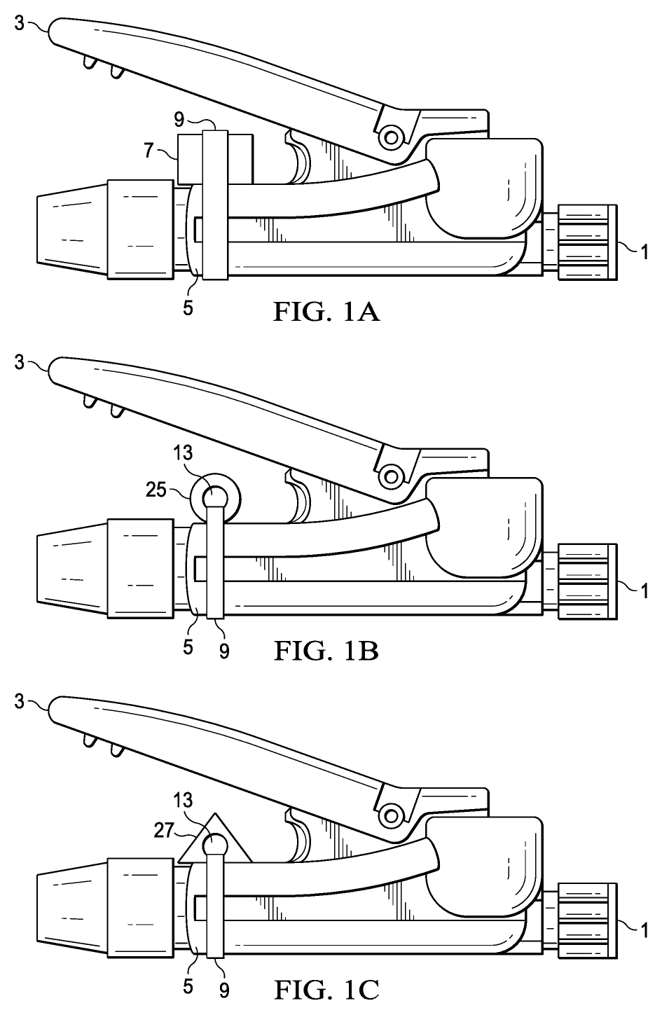

FIG. 1A illustrates how a flow control device 7 can be affixed, in one embodiment of the invention, to a nozzle apparatus 1 having an upper lever portion 3 and a lower portion 5. The flow control device 7 as shown in this embodiment is in the form of a rectangular block. The flow control device 7 is not limited to being in the form of a rectangular block. The flow control device 7 may have various cross-sectional area shapes such as, but not limited to: a circle, a triangle, a square, a rectangle, a trapezoid, a pentagon, a hexagon, an octagon, or a star. The flow control device 7 may be composed of any sort of mostly rigid material such as but not limited to: plastic, wood, metal, rigid polystyrene, or rubber. The flow control device 7 as shown in this embodiment has a fastener 9 that passes over the top of the flow control device 7 and passes around the lower portion 5 of the nozzle apparatus 1. The fastener 9 as displayed in this embodiment is in the form of a band, but it is not limited to only this structure. The fastener 9 could be any sort of means for fastening such as but not limited to: a plastic ratchet fastener, glue, a screw, a nail, a hinge, a compression fitting, rope, string, a quick tie, a pipe fastener, or any other fastener known to those in the art.

The nozzle apparatus 1 functions by the compression of the upper lever portion 3 and the lower portion 5. These two portions 3, 5 are pivotally mounted to the handle to actuate a valve within the nozzle apparatus 1. The valve is a type of valve that allows for variable flow rates in relation to the displacement of the valve. The displacement is controlled by the depression of the upper lever portion 3 toward to the lower portion 5 when the portions 3, 5 are gripped by a user and squeezed together. Thus, the flow control device 7 functions to limit the flowrate of the nozzle apparatus 1 by preventing the full depression of the upper lever portion 3 to the lower portion 5. By limiting the range of motion of the upper lever portion 3, the valve releasing the pressurized water from a water tanker system is only partially opened and thus the pressure and resulting flowrate of the water stream is reduced to a more manageable level. This reduction in flowrate helps to conserve water by making the water stream more manageable.

FIG. 1B illustrates another embodiment of a flow control device 25 attached to the lower portion 5 of the nozzle apparatus 1. The flow control device 25 is attached utilizing a fastener 9 that runs through a hole 13 in the flow control device 25 and around the lower portion 5 of the nozzle apparatus 1. The flow control device 25 in this embodiment is shown as a block with a circular cross-sectional area and is thus more cylindrical in nature. The application of the flow control device 25 functions the same as the above embodiment in which the valve supplying the water is controlled by preventing the upper lever portion 3 of the nozzle apparatus 1 from fully depressing to the lower portion 5 of the nozzle apparatus 1.

FIG. 1C illustrates another embodiment of a flow control device 27 attached to the lower portion 5 of the nozzle apparatus 1. The flow control device 27 is attached utilizing a fastener 9 that runs through a hole 13 in the flow control device 27 and around the lower portion 5 of the nozzle apparatus 1. The flow control device 27 in this embodiment is shown as a block with a triangular cross-sectional area. The application of the flow control device 27 functions the same as the previous embodiments in which the valve supplying the water is controlled by preventing the upper lever portion 3 of the nozzle apparatus 1 from fully depressing to the lower portion 5 of the nozzle apparatus 1.

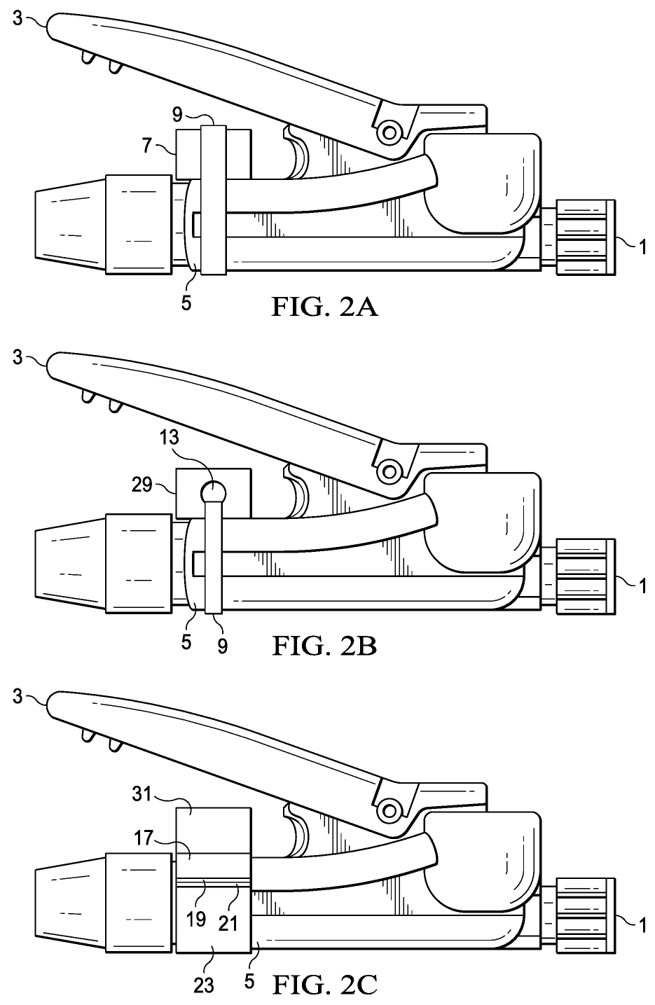

FIG. 2A illustrates the rectangular flow control device 7 attached to the lower portion 5 of the nozzle apparatus 1. The flow control device 7 is attached utilizing a fastener 9 over the top of the flow control device 7 and around the lower portion 5 of the nozzle apparatus 1. The application of the flow control device 7 functions the same as the above embodiment in which the valve supplying the water is controlled by preventing the upper lever portion 3 of the nozzle apparatus 1 from fully depressing to the lower portion 5 of the nozzle apparatus 1.

FIG. 2B illustrates another embodiment of a flow control device 29 attached to the lower portion 5 of the nozzle apparatus 1. The flow control device 29 is attached utilizing a fastener 9 which runs through a hole 13 through the flow control device 29 and around the lower portion 5 of the nozzle apparatus 1. The flow control device 29 in this embodiment is shown as a block with a rectangular cross-sectional area. The application of the flow control device 29 functions the same as the above embodiment in which the valve supplying the water is controlled by preventing the upper lever portion 3 of the nozzle apparatus 1 from fully depressing to the lower portion 5 of the nozzle apparatus 1.

FIG. 2C illustrate yet another embodiment of a flow control device 31 attached to the lower portion 5 of the nozzle apparatus 1. In this embodiment, the flow control device 31 is comprised of three parts: the flowrate regulating portion 31, one body that partially extrudes on one side 17 of the flow control device 31, and one body that extrudes from the other side 23 of the flow control device 31. The flow control device 31 attaches to the lower portion 5 of the nozzle apparatus 1 by combing the one extrusion 17 and the other extrusion 23 together through a joining mechanism comprising a top 19 and bottom 21 part. The joining mechanism 19, 21 may be a latch, Velcro, a compression fitting, a pin, or other method known to one in the art. The extrusions 17, 23 may also be made of a flexible and elastic material such that there is only one extrusion body which can be expanded to fit around the lower portion 5 of the nozzle apparatus 1 and then under elastic forces it would secure the flow control device 31. The application of the flow control device 31 functions the same as the above embodiments in which the valve supplying the water is controlled by preventing the upper lever portion 3 of the nozzle apparatus 1 from fully depressing to the lower portion 5 of the nozzle apparatus 1.

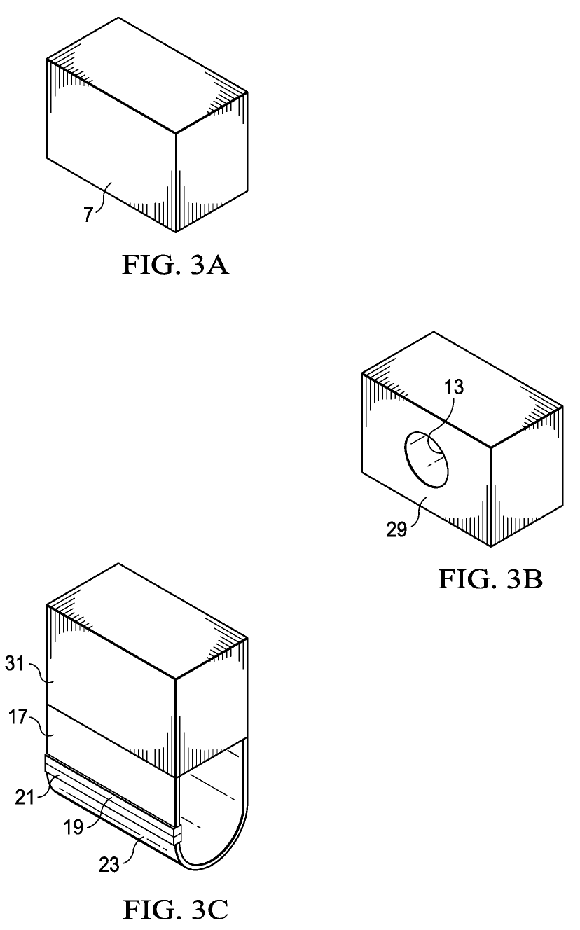

FIG. 3A shows one embodiment of a flow control device 7. The flow control device in this embodiment is a block with a rectangular cross-sectional area. This simple form is easy to produce and thus lowers the costs associated with fitting the flow control device 7 to the water tanker.

FIG. 3B shows another embodiment of a flow control device 29. The flow control device in this embodiment is a block with a rectangular cross-sectional area. The block has a hole 13 that runs the length of it to allow for a fastener to be inserted through it.

FIG. 3C illustrates another embodiment of a flow control device 31. In this embodiment, the flow control device 31 is comprised of three parts: the flowrate regulating portion 31, one body that partially extrudes on one side 17 of the flow control device 31, and one body that extrudes from the other side 23 of the flow control device 31. The flow control device 31 attaches to the lower portion 5 of the nozzle apparatus 1 by combing the one extrusion 17 and the other extrusion 23 together through a joining mechanism comprising a top 19 and bottom 21 part. The joining mechanism 19, 21 may be a latch, Velcro, a compression fitting, a pin, or other method known to one in the art.

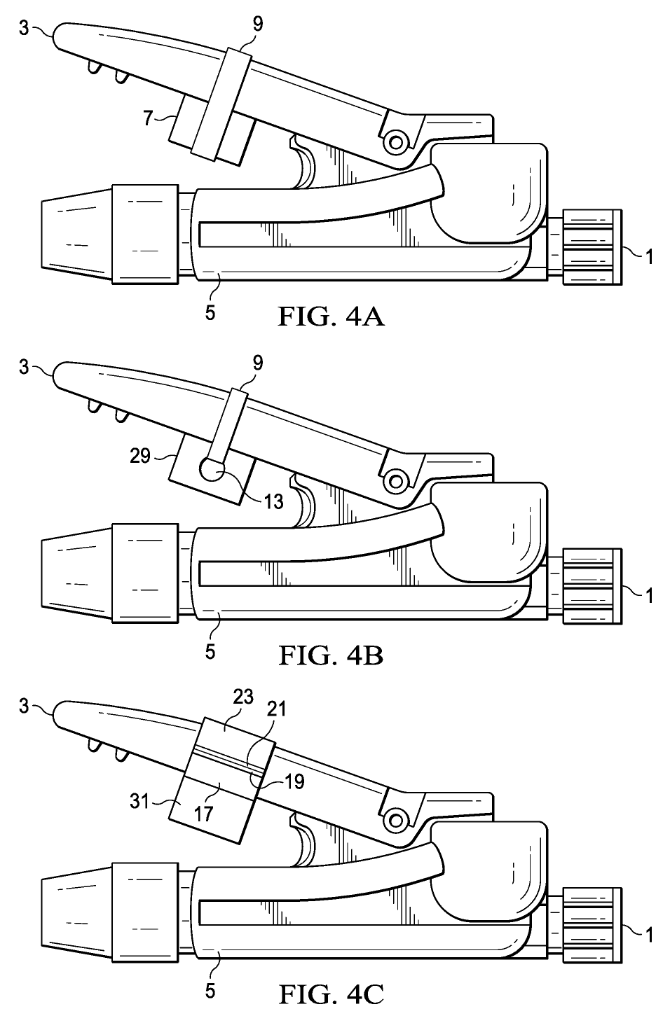

FIG. 4A illustrates a different embodiment of the flow control device 7 attached to the upper lever portion 3 of the nozzle apparatus 1. The flow control device 7 is attached utilizing a fastener 9 over the top of the flow control device 7 and around the upper lever portion 3 of the nozzle apparatus 1. The flow control device 7 in this embodiment is shown as a block with a rectangular cross-sectional area. The application of the flow control device 7 functions similar to the embodiments where the flow control device 7 is affixed to the lower portion 5 of the nozzle apparatus 1, namely, the valve supplying the water is controlled by preventing the upper lever portion 3 of the nozzle apparatus 1 from fully depressing to the lower portion 5 of the nozzle apparatus 1.

FIG. 4B illustrates another embodiment of the flow control device 29 attached to the upper lever portion 3 of the nozzle apparatus 1. The flow control device 29 is attached utilizing a fastener 9 which runs through a hole 13 through the flow control device 29 and around the upper lever portion 3 of the nozzle apparatus 1. The flow control device 29 in this embodiment is shown as a block with a rectangular cross-sectional area. The application of the flow control device 29 functions similar to the embodiments where the flow control device 29 is affixed to the lower portion 5 of the nozzle apparatus 1 in which the valve supplying the water is controlled by preventing the upper lever portion 3 of the nozzle apparatus 1 from fully depressing to the lower portion 5 of the nozzle apparatus 1.

FIG. 4C illustrate yet another embodiment of the flow control device 31 attached to the upper lever portion 3 of the nozzle apparatus 1. In this embodiment, the flow control device 31 is comprised of three parts: the flowrate regulating portion 31, one body that partially extrudes on one side 17 of the flow control device 31, and one body that extrudes from the other side 23 of the flow control device 31. The flow control device 31 attaches to the upper lever portion 3 of the nozzle apparatus 1 by combing the one extrusion 17 and the other extrusion 23 together through a joining mechanism comprising a top 19 and bottom 21 part. The joining mechanism 19, 21 may be a latch, Velcro, a compression fitting, a pin, or other method known to one in the art. The extrusions 17, 23 may also be made of a flexible and elastic material such that there is only one extrusion body which can be expanded to fit around the upper lever portion 3 of the nozzle apparatus 1 and then under elastic forces it would secure the flow control device 31. The application of the flow control device 31 functions similar to the embodiments where the flow control device 31 is affixed to the lower portion 5 of the nozzle apparatus 1 in which the valve supplying the water is controlled by preventing the upper lever portion 3 of the nozzle apparatus 1 from fully depressing to the lower portion 5 of the nozzle apparatus 1.

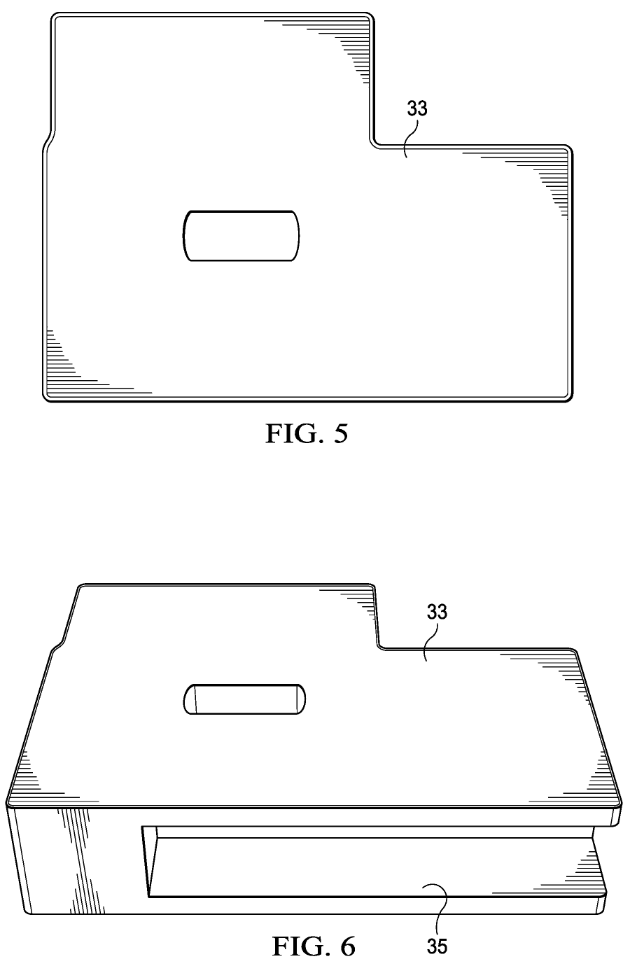

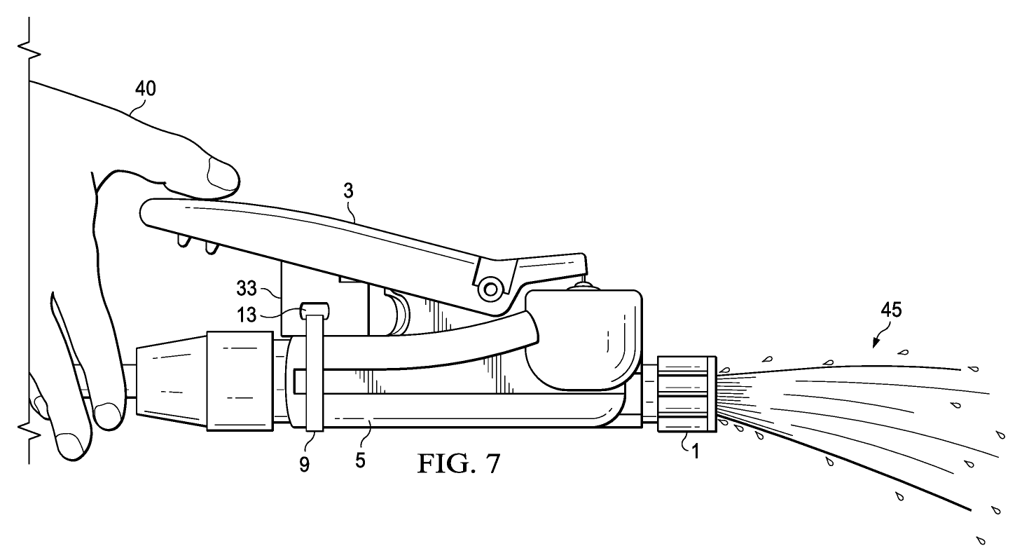

FIG. 5 and FIG. 6 illustrate perspective top and bottom views, respectively, of another embodiment of a flow control device 33 shown as an L-shaped trapezoid block with a rectangular cross-section along at least one side. As shown in FIG. 6, the bottom portion 35 of the flow control device 33 may be concave or hollow. FIG. 7 further illustrates the flow control device 33 attached to the lower portion 5 of the nozzle apparatus 1. The flow control device 33 is attached utilizing a fastener 9 which runs through a hole 13 through the flow control device 33 and around the lower portion 5 of the nozzle apparatus 1. As depicted in FIG. 7, during operation of the nozzle apparatus 1, when a user 40 depresses the upper lever portion 3 of the nozzle apparatus 1 toward the lower portion 5 of the nozzle apparatus 1 to deliver water 45, the upper lever portion 3 engages the top of the flow control device 33. Thus, the flow control device 33 functions the same as the above embodiments in which the valve supplying the water 45 is controlled or limited by preventing the upper lever portion 3 of the nozzle apparatus 1 from fully depressing to the lower portion 5 of the nozzle apparatus 1.

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

1. A system for regulating a fluid pressure and a flowrate of pressurized fluid from a nozzle apparatus utilizing a lever action to open a valve blocking the flow of the pressurized fluid, comprising:
a body situated between an upper lever portion and a lower portion of the nozzle apparatus;
the body being affixed to the lower portion of the nozzle apparatus; and
the affixed body being located in such a position to prevent the upper lever portion from being depressed into contact with the lower portion.

2. The system of claim 1, wherein the body has a cross-sectional area of shape selected from the group consisting of: a square, a rectangle, a triangle, a circle, a trapezoid, an octagon, a pentagon, a hexagon, a star, or a combination thereof.

3. The system of claim 1, wherein the body is affixed using a fastener selected from the group consisting of: a plastic ratchet fastener, glue, a screw, a nail, a hinge, a compression fitting, a rope, a string, a quick tie, a pipe fastener, or a combination thereof.

4. The system of claim 1, wherein the body is made of a essentially rigid material selecting from the group consisting of: wood, metal, plastic, polymer, rigid polystyrene, or a combination thereof.

5. The system of claim 3, wherein the body and the fastener are adjustable so as to allow a user to move the body and the fastener to a desired position to get a desired flowrate.

6. The system of claim 1, wherein the body is a composite of various shape cross-sectional areas.

7. A system for regulating a fluid pressure and a flowrate of pressurized fluid from a nozzle apparatus utilizing a lever action to open a valve blocking the flow of the pressurized fluid, comprising:
a body situated between an upper lever portion and a lower portion of the nozzle apparatus;
the body being affixed to the upper lever portion of the nozzle apparatus; and
the affixed body being located in such a position to prevent the upper lever portion from being depressed into contact with the lower portion.

8. The system of claim 7, wherein the body has a cross-sectional area of shape selected from the group consisting of: a square, a rectangle, a triangle, a circle, a trapezoid, an octagon, a pentagon, a hexagon, a star, or a combination thereof.

9. The system of claim 7, wherein the body is affixed using a fastener selected from the group consisting of: a plastic ratchet fastener, glue, a screw, a nail, a hinge, a compression fitting, a rope, a string, a quick tie, a pipe fastener, or a combination thereof.

10. The system of claim 7, wherein the body is made of a essentially rigid material selecting from the group consisting of: wood, metal, plastic, polymer, rigid polystyrene, or a combination thereof.

11. The system of claim 9, wherein the body and the fastener are adjustable so as to allow a user to move the body and the fastener to a desired position to get a desired flowrate.

12. The system of claim 7, wherein the body is a composite of various shape cross-sectional areas.

13. The system of claim 7, wherein the body is affixed to the upper lever portion of the nozzle apparatus by a compression fitting and inserted within a hollow of the upper lever portion.

14. A system for regulating a fluid pressure and a flowrate of pressurized fluid from a nozzle apparatus utilizing a lever action to open a valve blocking the flow of the pressurized fluid, comprising:
a body situated between an upper lever portion and a lower portion of the nozzle apparatus;
the body having a first member that extrudes from one side of the body and a second member that extrudes from an opposite side of the body;
the two extrusion members when brought together having a roughly cylindrical shape;
the two extrusion members joined together by a joining mechanism with a top portion and a bottom portion; and
the body being affixed to the upper lever portion or the lower portion of the nozzle apparatus by securing the body utilizing the two extrusion members and joining them together with the joining mechanism.

15. The system of claim 14, wherein the body has a cross-sectional area of shape selected from the group consisting of: a square, a rectangle, a triangle, a circle, a trapezoid, an octagon, a pentagon, a hexagon, a star, or a combination thereof.

16. The system of claim 14, wherein the joining mechanism is selected from the group consisting of: a latch, Velcro, a compression fitting, a pin, or a combination thereof.

17. The system of claim 14, wherein the body is made of an essentially rigid material selecting from the group consisting of: wood, metal, plastic, polymer, rigid polystyrene, or a combination thereof.

18. A system of claim 14, wherein the body and the joining mechanism are adjustable so as to allow a user to move the body and the joining mechanism to a desired position to get a desired flowrate.

19. The system of claim 1, wherein the body has a cross-sectional area of an L-shaped trapezoid.

20. The system of claim 7, wherein the body has a cross-sectional area of an L-shaped trapezoid.
